(19) United States
(12) Patent Application Publication
(10) Pub. No.: US 2026/0162357 A1
(43) Pub. Date: Jun. 11, 2026

(54) MULTI-VIEW SHARED LATENT SPACE MODELING

(71) Applicant: Toyota Research Institute, Inc., Los Altos, CA (US)

(72) Inventors: Jiali Cui, Los Altos, CA (US); Yin-Ying Chen, San Jose, CA (US); Yanxia Zhang, Foster City, CA (US); Matthew K. Hong, Mountain View, CA (US); Matthew Evans Klenk, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/050,566

(22) Filed: Feb. 11, 2025

Related U.S. Application Data
(60) Provisional application No. 63/728,891, filed on Dec. 6, 2024.

(51) Int. Cl. G06T 15/20; G08G 1/16

(52) U.S. Cl. CPC G06T 15/20; G08G 1/16

(57) ABSTRACT

Systems, methods, and other embodiments described herein relate to multi-view generation using a shared latent space. In one embodiment, a method includes acquiring a request to generate an image. The method includes generating a latent code from the request using a diffusion model that learns a shared latent space defining relationships between separate views of objects. The method includes decoding the latent code into the image using a decoder trained on the shared latent space. The method includes providing the image.

### CROSS-REFERENCE TO RELATED APPLICATIONS

This application claims priority to U.S. Provisional Application No. 63/728,891, filed on Dec. 6, 2024, which is herein incorporated by reference in its entirety.

### TECHNICAL FIELD

The subject matter described herein relates, in general, to systems and methods for multi-view generation and, in particular, to generating a shared latent space to facilitate multi-view generation using latent codes.

### BACKGROUND

The rapid advancement of computer vision, machine learning, and generative modeling has greatly expanded the capabilities of designing and creating high-quality multi-view images, particularly in fields such as computer-aided design (CAD), 3D modeling, and augmented reality. Multi-view image generation involves creating images or representations of an object from different perspectives, such as from the front, side, or back, or from different modalities, such as surface fields, sketches, styles, or segments. These images are often used in various applications, including product design, virtual reality, environment simulation, vehicle planning, and image-based 3D reconstruction. However, current methods for generating multi-view images have several limitations that hinder their effectiveness and efficiency.

One of the primary challenges in prior approaches is the difficulty of generating consistent, high-quality images from multiple views. Most existing techniques focus on generating a single view from a single image and then attempt to extrapolate the other views from that initial view. These methods, often rely on traditional image-to-image translation or 2D-to-3D methods, struggle to maintain coherence between views and to preserve the design details across different perspectives or modalities. For example, when attempting to generate a multi-view model from a single sketch or a surface field, the resulting images may suffer from inconsistencies, distortions, or missing details that undermine the utility and accuracy of the design. Furthermore, the lack of shared understanding between the different views makes it difficult to propagate modifications across all views in a meaningful and coordinated manner, leading to significant manual effort to adjust each view separately.

Another problem with existing methods is the absence of a robust shared representation of the object or design across different views and modalities. Most techniques rely on separate models for each view or modality, making it difficult to capture the common, underlying design concepts. These methods struggle to capture the interactions and relationships between different views in a way that enables efficient, high-quality generation. As a result, iterative modifications, such as blending, or geometric adjustments, often fail to propagate correctly across all views, leading to a lack of consistency between the different perspectives.

### SUMMARY

Example systems and methods relate to multi-view generation using a shared latent space. As noted previously, multi-view generation is a complex task that encounters many different difficulties. In particular, many approaches encounter difficulties with maintaining consistency among separate views because, for example, these approaches may generate a single view and then iteratively adapt the view into other views. The resulting images often suffer from inconsistencies because of a lack of knowledge of the overall geometry.

Various embodiments described here address these challenges by introducing a novel multi-view shared latent generative model that captures common design concepts in a shared latent space, enabling a unified and consistent representation of the object across multiple views and modalities. By utilizing a diffusion model trained over a shared latent space, the invention allows for the generation of a shared latent code, which can then be decoded into high-quality, consistent multi-view images. This approach ensures that the underlying design is preserved and coherent across all perspectives. In particular, in one or more examples, a method provides robustness by leveraging the shared latent space to ensure consistency and high quality in the generated images, even in the presence of complex or ambiguous input data.

Accordingly, various disclosed approaches provide a more powerful and efficient method for generating multi-view images from multiple modalities and perspectives, while overcoming the limitations of consistency. By using a shared latent space to capture common features and relationships between different views, the described systems and methods enhance both the quality and the flexibility of multi-view image generation, offering significant advantages for generating multi-modal representations.

By way of example, consider that an inventive system implements a two-stage training approach to initially derive a shared latent space and learn shared latent codes within the shared latent space. For example, the system, in a first stage of training, initially acquires a training dataset that is comprised of sets of multi-view images. Each set depicts an object or combination of objects with each separate image providing a different view, e.g., from different relative poses. An image model is composed of an image encoder and an image decoder. The system generates latent codes from the images using the image encoder. The latent codes are abstract representations of the images in the form of, for example, feature vectors. The system then uses the image decoder to re-generate the original images for each set from which the system can derive a loss value and train the image model. Of course, in various arrangements, the particular approach for training may vary to, for example, remove one of the images from the set (e.g., for multi-view completion), and so on. In any case, training the image model forms the shared latent space as a defined feature space that has learned the geometric relationships between different views of objects.

The system can then, in a second stage of training, train a diffusion model on the shared latent space using the latent codes generated by the image encoder. For example, the system may add noise to the latent codes and the diffusion model then operates to denoise the latent codes to derive the originals. This allows the diffusion model to learn the shared latent space from an abstract mechanism of the latent codes. Once trained, the diffusion model can accept requests to generate multi-view images in combination with the image decoder. For example, in the context of multi-view image completion, the diffusion model processes the set of images that are missing an image as an input and provides a latent code that maps to the shared latent space. This latent code can then be processed by the image decoder to provide the multi-view set of images with the missing image. In this way, the system is able to leverage the shared latent space to improve various tasks for multi-view generation.

In one embodiment, a design system is disclosed. The design system includes one or more processors and a memory communicably coupled to the one or more processors. The memory stores instructions that, when executed by the one or more processors, cause the one or more processors to acquire a request to generate an image. The instructions include instructions to generate a latent code from the request using a diffusion model that learns a shared latent space defining relationships between separate views of objects. The instructions include instructions to decode the latent code into the image using a decoder trained on the shared latent space. The instructions include instructions to provide the image.

In one embodiment, a non-transitory computer-readable medium including instructions that, when executed by one or more processors, cause the one or more processors to perform various functions is disclosed. The instructions include instructions to acquire a request to generate an image. The instructions include instructions to generate a latent code from the request using a diffusion model that learns a shared latent space defining relationships between separate views of objects. The instructions include instructions to decode the latent code into the image using a decoder trained on the shared latent space. The instructions include instructions to provide the image.

In one embodiment, a method is disclosed. The method includes acquiring a request to generate an image. The method includes generating a latent code from the request using a diffusion model that learns a shared latent space defining relationships between separate views of objects. The method includes decoding the latent code into the image using a decoder trained on the shared latent space. The method includes providing the image.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a design system associated with using a shared latent space for multi-view generation.

FIG. 2 illustrates one embodiment of the system of FIG. 1 integrated within a cloud-based environment.

FIG. 3 is an illustration of a first phase of a two-stage training process.

FIG. 4 is an illustration of a second phase of a two-stage training process.

FIG. 5 is an illustration of inference for generating multi-view images using a shared latent space.

FIG. 6 is a flowchart illustrating one embodiment of a method for generating a shared latent space.

FIG. 7 is a flowchart illustrating one embodiment of a method for inferring multi-view images using a shared latent space.

FIG. 8 illustrates an example of style transfer.

FIG. 9 illustrates an example of multi-view completion.

FIG. 10 illustrates an example of multi-view generation.

### DETAILED DESCRIPTION

Systems, methods, and other embodiments associated with multi-view generation using a shared latent space are disclosed. As noted previously, multi-view generation is a complex task that encounters many different difficulties. In particular, many approaches encounter difficulties with maintaining consistency among separate views because, for example, these approaches may generate a single view and then iteratively adapt the view into other views. The resulting images often suffer from inconsistencies because of a lack of knowledge of the overall geometry.

Various embodiments described here address these challenges by introducing a novel multi-view shared latent generative model that captures common design concepts in a shared latent space, enabling a unified and consistent representation of the object across multiple views and modalities. By utilizing a diffusion model trained over a shared latent space, the invention allows for the generation of a shared latent code, which can then be decoded into high-quality, consistent multi-view images. This approach ensures that the underlying design is preserved and coherent across all perspectives. In particular, in one or more examples, a method provides robustness by leveraging the shared latent space to ensure consistency and high quality in the generated images, even in the presence of complex or ambiguous input data.

Accordingly, various disclosed approaches provide a more powerful and efficient method for generating multi-view images from multiple modalities and perspectives, while overcoming the limitations of consistency. By using a shared latent space to capture common features and relationships between different views, the described systems and methods enhance both the quality and the flexibility of multi-view image generation, offering significant advantages for generating multi-modal representations.

By way of example, consider that an inventive system implements a two-stage training approach to initially derive a shared latent space and learn shared latent codes within the shared latent space. For example, the system, in a first stage of training, initially acquires a training dataset that is comprised of sets of multi-view images. Each set depicts an object or combination of objects with each separate image providing a different view, e.g., from different relative poses. An image model is composed of an image encoder and an image decoder. The system generates latent codes from the images using the image encoder. The latent codes are abstract representations of the images in the form of, for example, feature vectors. The system then uses the image decoder to re-generate the original images for each set from which the system can derive a loss value and train the image model. Of course, in various arrangements, the particular approach for training may vary to, for example, remove one of the images from the set (e.g., for multi-view completion), and so on. In any case, training the image model forms the shared latent space as a defined feature space that has learned the geometric relationships between different views of objects.

The system can then, in a second stage of training, train a diffusion model on the shared latent space using the latent codes generated by the image encoder. For example, the system may add noise to the latent codes and the diffusion model then operates to denoise the latent codes to derive the originals. This allows the diffusion model to learn the shared latent space from an abstract mechanism of the latent codes. Once trained, the diffusion model can accept requests to generate multi-view images in combination with the image decoder. For example, in the context of multi-view image completion, the diffusion model processes the set of images that are missing an image as an input and provides a latent code that maps to the shared latent space. This latent code can then be processed by the image decoder to provide the multi-view set of images with the missing image. In this way, the system is able to leverage the shared latent space to improve various tasks for multi-view generation.

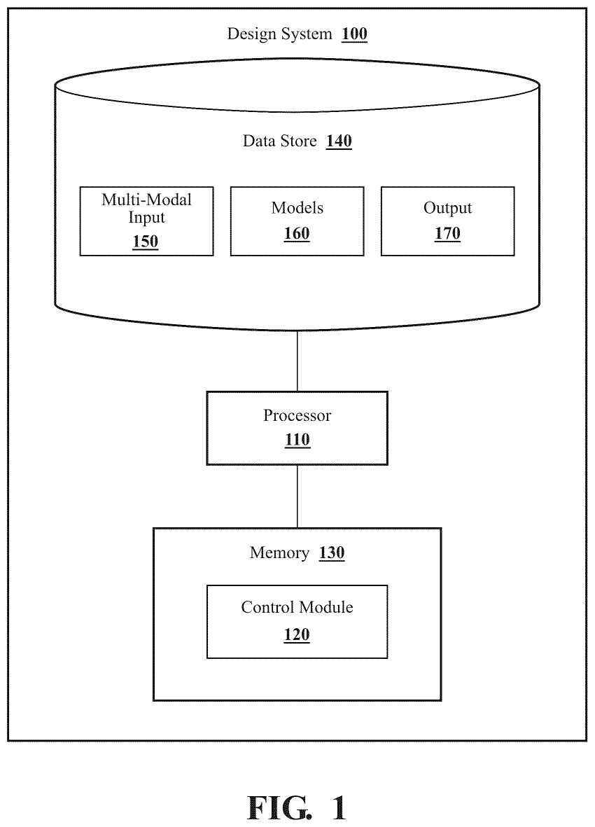

Referring to FIG. 1, one example of a design system 100 that uses a shared latent space to generate multi-view images is shown. While depicted as a standalone component, in one or more embodiments, the design system 100 is cloud-based and thus can include elements that are distributed among different locations. In general, the design system 100 is implemented to facilitate creation of the shared latent space and the subsequent use of the shred latent space to generate multi-view images. The noted functions and methods will become more apparent with a further discussion of the figures.

With further reference to FIG. 1, one embodiment of the design system 100 is further illustrated. The design system 100 is shown as including a processor 110. Accordingly, the processor 110 may be a part of the design system 100, or the design system 100 may access the processor 110 through a data bus or another communication path. In one or more embodiments, the processor 110 is an application-specific integrated circuit (ASIC) that is configured to implement functions associated with a control module 120. In general, the processor 110 is an electronic processor, such as a microprocessor that is capable of performing various functions as described herein. In one embodiment, the design system 100 includes a memory 130 that stores the control module 120 and/or other modules that may function in support of generating depth information. The memory 130 is a random-access memory (RAM), read-only memory (ROM), a hard disk drive, a flash memory, or other suitable memory for storing the control module 120. The control module 120 is, for example, computer-readable instructions that, when executed by the processor 110, cause the processor 110 to perform the various functions disclosed herein. In further arrangements, the control module 120 is a logic, integrated circuit, or another device for performing the noted functions that includes the instructions integrated therein.

Furthermore, in one embodiment, the design system 100 includes a data store 140. The data store 140 is, in one arrangement, an electronic data structure stored in the memory 130 or another electronic medium, and that is configured with routines that can be executed by the processor 110 for analyzing stored data, providing stored data, organizing stored data, and so on. Thus, in one embodiment, the data store 140 stores data used by the control module 120 in executing various functions. For example, as depicted in FIG. 1, the data store 140 includes the multi-modal inputs 150, models 160 that are, in at least one approach, machine-learning models, and an output 170, along with, for example, other information that is used and/or produced by the control module 120. While the design system 100 is illustrated as including the various elements, it should be appreciated that one or more of the illustrated elements may not be included within the data store 140 in various implementations. In any case, the design system 100 stores various data elements in the data store 140 to support functions of the control module 120.

Continuing with the highlighted data elements, the multi-modal input 150, in at least one approach, includes different information depending on whether the design system 100 is training the models 160 or inferring the output 170 after training. For example, within the context of training, the multi-modal input includes sets of multi-view images of three-dimensional objects. That is, each set includes multiple separate views of the same object(s). The separate views are from different angles or field-of-views (FoVs) within three-dimensional space relative to the object(s). As one example, the separate views may be taken at 30-degree increments revolving around the object. Of course, in further arrangements, the different views may be taken from different elevations or rotations of the object(s). Moreover, the number of different views may also vary. In one example, each set of multi-view images includes sixteen different and distinct views of the object(s).

With further reference to the multi-modal input 150, during inference, the multi-modal input 150 is specific to the particular application that is implemented. For example, the design system 100 may implement specific tasks associated with multi-view generation. The tasks can include unconditional multi-view generation, multi-view completion, iterative multi-view editing, multi-view style transfer, and single-to-multiview generation. Accordingly, within this context the multi-modal input 150 may include a single image, a latent code, a partial set of multi-view images, a full set of multi-view images, and so on.

Continuing with the elements shown in the data store 140, the models 160 are, in one arrangement, machine-learning models and/or other algorithms. In one arrangement, the models 160 include a diffusion model and an image model that is comprised of an image encoder and an image decoder. Each of the models 160, in at least one approach, serve a different purpose within the design system 100. The image model functions to form the shared latent space through a training process and subsequently to decode shared latent codes. The diffusion model functions to learn the shared latent space and generate the shared latent codes from the multi-modal input 150 during inference.

The image model, in one or more arrangements, may be a generative model, such as a transformer-based network, an autoencoder, or another network that can accept images as inputs and generate reconstructed images as outputs. The diffusion model may be a transformer-based network, a convolutional-based network, or another network that learns to denoise data inputs in order to generate shared latent codes. The particular approach to training the models 160 to generate the noted outputs, including the shared latent space will be described in greater detail subsequently.

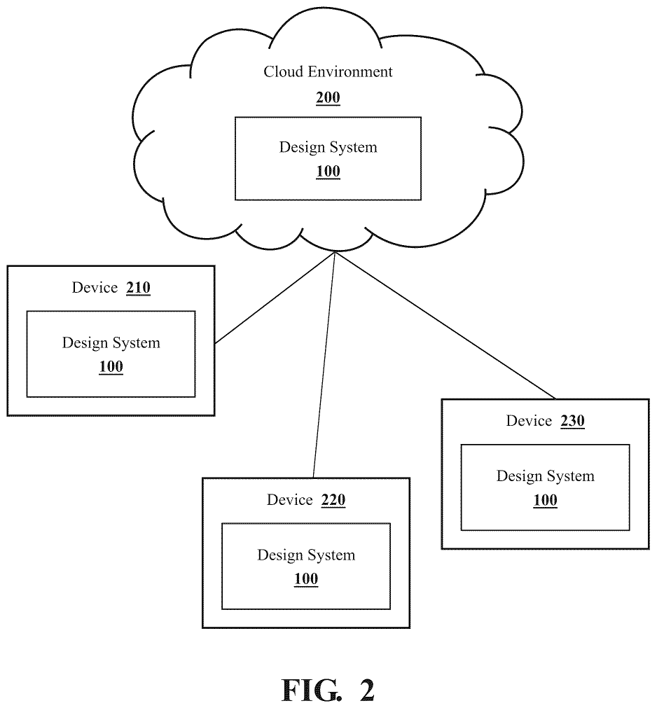

A further embodiment of the design system 100 is illustrated in FIG. 2. As previously noted, the design system 100 may be implemented within, for example, a cloud-based environment 200, as illustrated in relation to FIG. 2. That is, for example, the design system 100 may acquire data (e.g., multi-modal input 150) from client instances within the devices 210, 220, and 230 and perform analysis at a remote server that is integrated as part of the cloud environment 200. Accordingly, the instances of the design system 100 within the devices 210, 220, and 230 communicate via wired or wireless connections with the cloud environment 200. For example, the communications may be via a cellular network (e.g., Frequency-Division Multiple Access (FDMA), Code-Division Multiple Access (CDMA), etc.), a peer-to-peer (P2P) based network, WiFi, DSRC, V2I, V2V or another communication protocol that is capable of conveying the multi-modal input 150 and determinations according thereto between the entities.

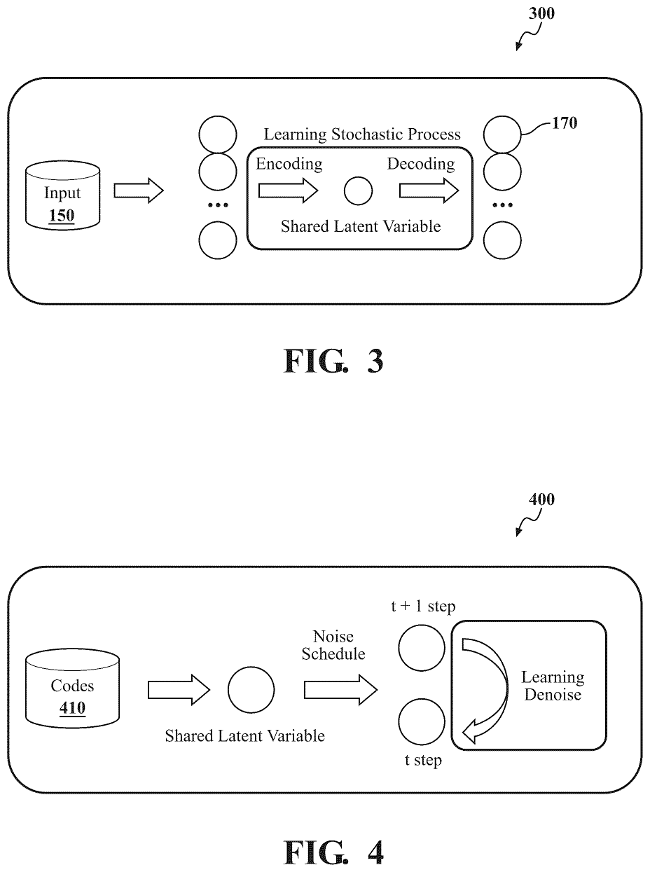

With reference to FIGS. 3-4, different stages of a two-stage training process are described. FIG. 3 illustrates a first stage 300 in which an image model that includes an image encoder and an image decoder is trained. The image model is trained on a set of training examples that is comprised of multi-view images of objects. As outlined previously in relation to the multi-modal input 150, the training examples include sets of multi-view images of the same object(s). The control module 120 implements the first stage 300 by using the image encoder to encode the multi-view images for a current example. The resulting shared latent codes/variables map to a shared latent space that is an abstracted representation of the images provided as inputs. After generating the shared latent codes, the control module 120 controls the image decoder to input the shared latent codes and output reconstructed images that are intended to mirror the original inputs. In one example, the control module 120 then generates a loss value (e.g., L2 loss) by comparing the original multi-view images with the reconstructed multi-view images. The control module 120 can then use the loss value to update the image model. Through this process the control module 120 defines the shared latent space. The first stage 300 is represented according to the following:

$$\begin{matrix}{β}_{} ( X , z ) = {β}_{} ( X \vert z ) ( z ) \\ = {β}_{} ( {x}_{1} , {x}_{2} , … , {x}_{n} \vert z ) ( z ) \\ = {{β}_{1}}_{} ( {x}_{1} \vert z ) {{β}_{2}}_{} ( {x}_{2} \vert z ) … {{β}_{n}}_{} ( {x}_{n} \vert z ) p ( z ) \\ = {\prod }_{i = 1}^{n} {{β}_{i}}_{} ( {x}_{i} \vert z ) ( z )\end{matrix}$$

$$( z ) ∼ N ( 0 , {I}_{d} ) {{β}_{i}}_{} ( {x}_{i} \vert z ) ∼ N ( {μ}_{{β}_{i}} ( z ) , {V}_{{β}_{i}} ( z ) ) {q}_{ϕ} ( z \vert X ) ∼ N ( {μ}_{ϕ} ( X ) , {V}_{ϕ} ( X ) )$$

Where [symbol] z is a shared latent variable, X is a multi-view observed example, and xi is the i^{th} view observed example. The result of the first stage is that the shared latent space is now defined for a broad set of examples as embodied within the training data.

With reference to FIG. 4, a second stage 400 is shown. In the second stage, the control module 120 uses the shared latent codes 410 as generated by the image encoder from the first stage 300. In particular, the control module 120 uses the shared latent codes 410 to train a diffusion model on the shared latent space as provided for in the first stage 300. To achieve this, the control module 120 adds noise to the shared latent codes 410 according to a noise schedule a, which may be Gaussian noise another form. In general, adding the noise to the shared latent codes 410 obscures the codes 410. The control module 120 may then train the diffusion model by controlling the diffusion model to denoise the noised latent codes 410 in a stepwise manner through a diffusion process. In this way, the control module 120 trains the diffusion model on the shared latent space through the shared latent codes 410 that map onto the shared latent space. The denoising model (e.g., the diffusion model) is represented by [symbol] _{θ}_{ₜ}( [symbol] ₜ| [symbol] ₜ₊₁), a is the noise schedule, and a stationary distribution at the final step is represented as q( [symbol] _{T})˜N(0, l_{d}).

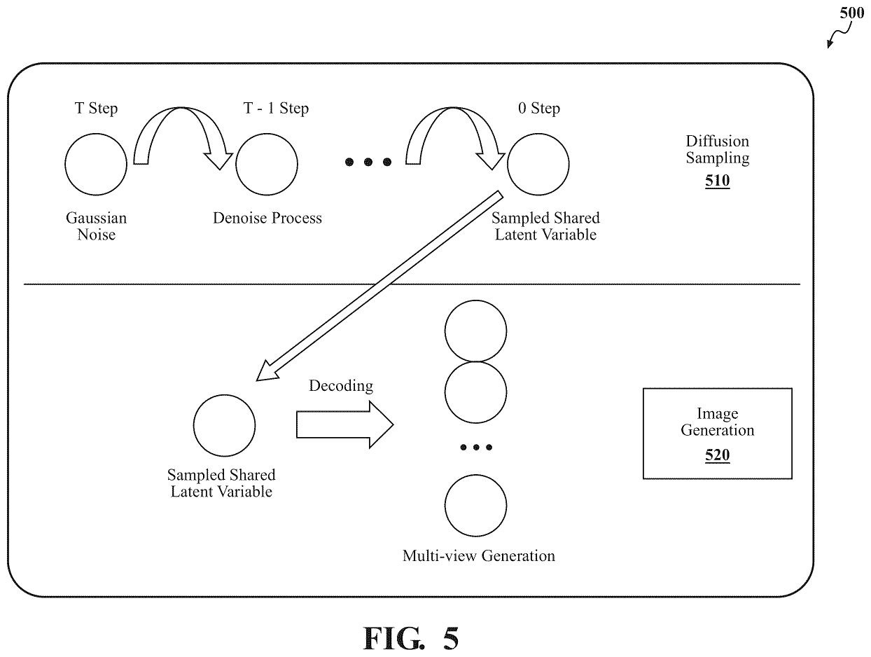

With reference to FIG. 5, an illustration of an inference process 500 using the shared latent space is shown. As shown in FIG. 5, the inference process 500 is comprised of two separate parts, including diffusion sampling 510 and image generation 520. The diffusion sampling 510 involves the use of the diffusion model to generate a shared latent code. Thus, the diffusion sampling 510 passes the generated shared latent code to the image generation stage 520, which includes the image decoder from the image model. The image model decodes the shared latent code from the diffusion model to generate the set of multi-view images as an output 170.

It should be noted that the diffusion model may accept different modalities of information as inputs. For example, depending on the particular implementation, the diffusion model may accept images, latent codes, and so on. In any case, the diffusion model executes a denoising process over the input data. Thus, the control module 120, in at least one arrangement, executes a process to add noise (e.g., Gaussian noise) to the input data (e.g., latent code), thereby obscuring the input. The diffusion model can then iteratively denoise the input and ultimately output a shared latent code that maps to the shared latent space. Thus, the diffusion model functions to correlate the input with the shared latent space, which has learned geometric relationships between separate views of objects.

As a result, the image decoder can decode the shared latent code into a set of multi-view images according to the specific implementation. That is, the image decoder generates the output 170 as multi-view completion (e.g., 10 images/views as inputs to 17 images/views as outputs), multi-view editing (e.g., extrapolating a change in one view to other views), style transfer (e.g., changing the style of a set of multi-view images), and so on. In this way, the design system 100 is able to use the shared latent space to improve multi-view generation among different tasks and while avoiding difficulties associated with prior approaches, such as inconsistencies in the generated multi-views.

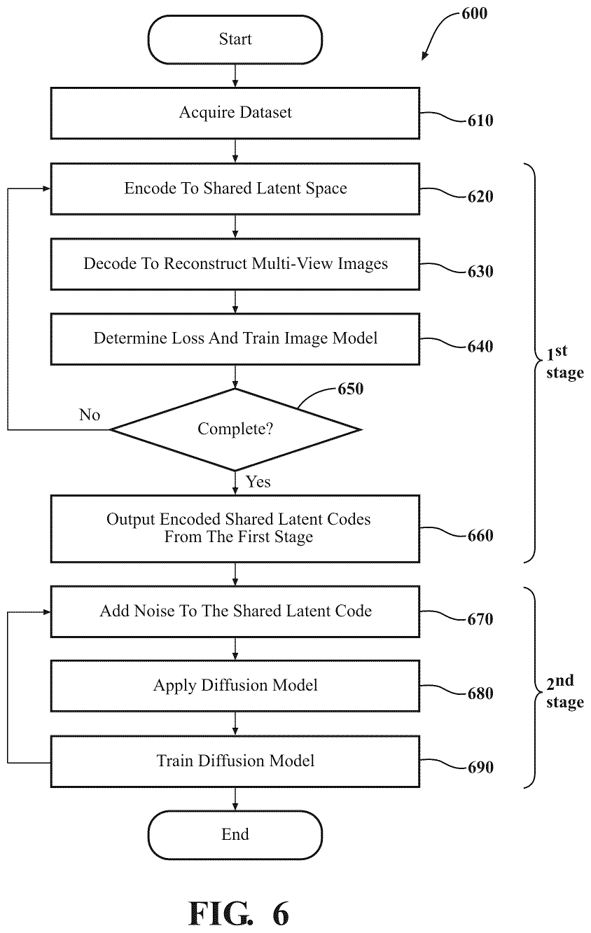

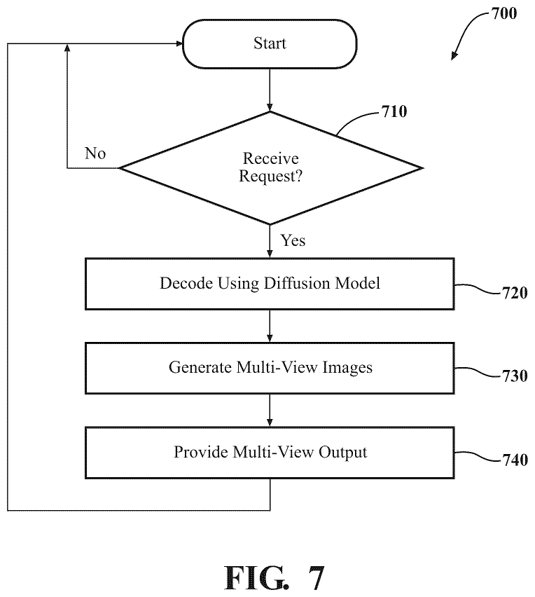

Additional aspects of generating a shared latent space and using the shared latent space to generate multi-view images will be discussed in relation to FIGS. 6-7. FIG. 6 illustrates a flowchart of a method 600 that is associated with training an image model and a diffusion model to learn a shared latent space. Method 600 will be discussed from the perspective of the design system 100 of FIG. 1. While method 600 is discussed in combination with the design system 100, it should be appreciated that the method 600 is not limited to being implemented within the design system 100 but is instead one example of a system that may implement the method 600.

At 610, the control module 120 acquires the multi-modal input 150. As indicated previously, the multi-modal input 150 includes sets of multi-view images for training but may include various other elements during inference. Moreover, the method 600 includes two separate stages of training. In the first stage, which includes 620-660, the control module 120 generates the shared latent space by training the image model using the multi-modal input 150. Subsequently, the second stage (670-690) operates to train the diffusion model, which uses the shared latent codes generated by the image encoder from the first stage.

At 620, the control module 120 uses the image encoder to encode a set of multi-view images. As previously noted, the control module 120 uses a training dataset that is comprised of sets of multi-view images to train the image model. Thus, for a single iteration, the image encoder encodes multiple images (e.g., 12, 16, etc.) that are separate views of a given object. In general, the separate views may be separated by a defined distance (e.g., degrees of rotation around the object); however, there is no specific requirement other than the images are derived from distinct viewpoints. In any case, the control module 120 encodes the images into a shared latent code that maps to the shared latent space. As a result of this encoding, the image encoder outputs shared latent codes that map to the shared latent space and, thereby, defines the shared latent space. The shared latent codes themselves are, for example, feature vectors that define abstracted features for each of the input images.

At 630, the control module 120 decodes the shared latent code to re-generate the images. That is, the control module 120 applies the image decoder of the image model to the shared latent code output by the image encoder. As a result, the image decoder reconstructs the original input images.

At 640, the control module 120 trains the image model according to a calculated loss. The calculated loss value is, for example, a L2 loss that is determined by, for example, comparing the output images from the image decoder with the original input images. This comparison may be a pixelwise comparison to determine differences between the input and the output images. In this way, the control module 120 can assess how closely the image decoder is able to reconstruct the original image but according to the abstraction of the shared latent code as mapped to the shared latent space. As a result, the design system 100 is able to create the shared latent space through training the image model on the training dataset of multi-view images.

At 650, the control module 120 determine whether the training is complete. The control module 120 may determine whether training is complete according to, for example, a threshold value. The threshold value may be a loss value or a change in the loss value between separate training iterations. Thus, when the loss, in one approach, converges to a value and, for example, does not change by more than a defined threshold (e.g., 5%) between successive iterations, then the control module 120 determines that the training of the image model is complete. Separately, in at least one approach, the control module 120 may define the threshold as a number of iterations of training. In either case, once training of the image model is complete, the shared latent space is formed, and the control module 120 proceeds with training the diffusion model on the shared latent space.

At 660, the control module 120 outputs the shared latent codes as encoded at block 620. That is, the control module 120 uses the shared latent codes generated by the image model to train the diffusion model. Because the shared latent codes from the first stage map to the shared latent space, using these codes facilitates training the diffusion model on the shared latent space.

At 670, the control module 120 adds noise to a shared latent code. In at least one approach, the control module 120 adds noise that obscures the underlying data. The control module 120 may generate the noise according to a Gaussian distribution. Of course, in further arrangements, the particular noise schedule may vary.

At 680, the control module 120 applies the diffusion model to denoise the shared latent codes. In at least one approach, the control module 120 may vary the amount of noise added to the shared latent codes in a progressive manner as the diffusion model is trained. In any case, the diffusion model functions to remove the noise and generate the shared latent code. This process causes the diffusion model to learn the shared latent space while correlating the input with the latent space.

At 690, the control module 120 trains the diffusion model according to the output. In at least one approach, the control module 120 assesses the output relative to the input to determine how well the diffusion model performed. The resulting loss value can be applied to the diffusion model to perform the training, which may be undertaken until the loss value converges/stabilizes. It should be appreciated that training of the diffusion model may vary depending on the task. For example, the task may include multi-view completion, multi-view style transfer, multi-view editing, unconditional multi-view generation, and single-to-multi-view generation. In some instances, the diffusion model is conditioned on different inputs depending on the task, such as images versus latent codes, image styles, and so on. In this way, the design system 100 is able to generate a shared latent space and a diffusion model that learns the shared latent space in order to subsequently facilitate multi-view generation.

FIG. 7 illustrates a flowchart of a method 700 that is associated with using the shared latent space derived from the method 600 to generate multi-view images. Method 700 will be discussed from the perspective of the design system 100 of FIG. 1. While method 700 is discussed in combination with the design system 100, it should be appreciated that the method 700 is not limited to being implemented within the design system 100 but is instead one example of a system that may implement the method 700.

At 710, the control module 120 acquires a request to generate an image. The control module 120 acquires the request which includes at least the multi-modal input 150. As indicated previously, the multi-modal input 150 may include images (e.g., a partial set of multi-view images) and/or a text description, which may take the form of a latent code. Depending on the particular implementation, the form of the request and the multi-modal input 150 may vary. For example, the request may include at least a partial set of multi-view images of an object and also an example image associated with a different style for the object (e.g., a representative object having a particular style). Thus, the request can include different acquired information depending on the specification implementation.

At 720, the control module 120 generates a latent code according to the input. For example, the control module 120 adds noise to acquired information from the request to form noised information. The control module 120 then provides the noised information to the diffusion model, which denoises the noised information to generate a shared latent code that maps to the shared latent space. This process allows the design system 100 to project the input into the abstracted representation of the shared latent space.

At 730, the control module 120 decodes the latent code into the image. It should be noted that while a single image is referenced, in various arrangements, the control module 120 uses the image decoder to generate a set of multi-view images. That is, the image decoder outputs a full set of images (e.g., 12, 16, etc.). Thus, the output 170 can include multiple images of an object that are each of a separate view of the object.

At 740, the control module 120 provides the output 170. In one approach, the control module 120 renders the output 170 on a display (e.g., center dashboard screen) within a vehicle to depict a previously unseen view of an object. Thus, the design system 100 may provide a view of an external environment; however, because certain aspects may be occluded (e.g., a far side of an object), the design system 100 can generate the views and then use the generated views to provide a different view of the object to a user in the vehicle, thereby improving situational awareness. As one example, the vehicle may render the view within a display associated with an advanced driving assistance system (ADAS), such as a collision avoidance system, rear cross-traffic alerts, etc. In further approaches, the control module 120 provides the output 170 as a 3D model, as code (e.g., g-code) for a 3D printer to generate a real model, as a schematic design, or in another form to assist in production or otherwise rendering the object in the image. In this way, the design system 100 improves the process of multi-view generation and, by extension, improves related processes, such as rendering scenes of a surrounding environment and so on.

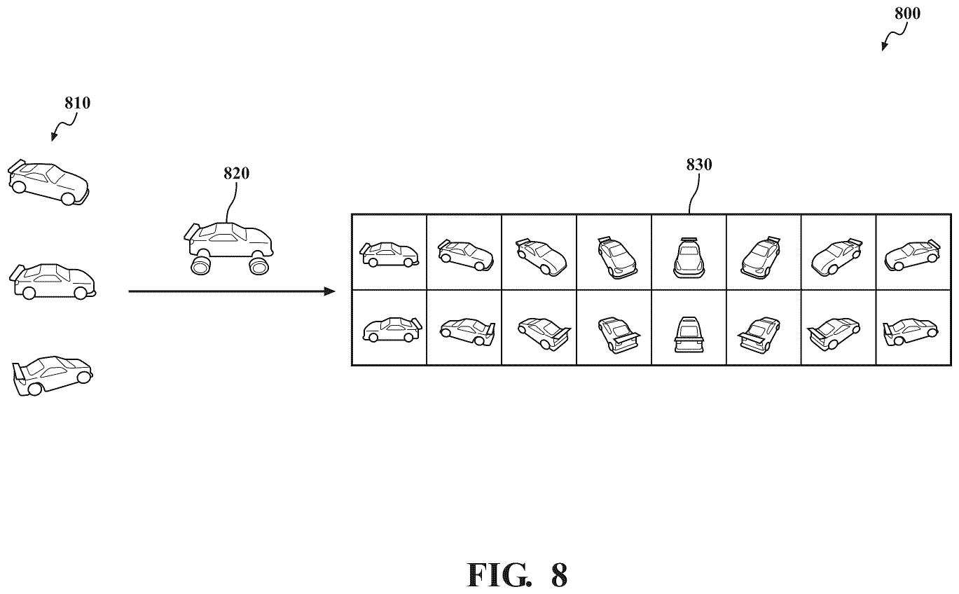

As further examples of how the design system 100 generates the output images 170, consider FIGS. 8-10, which illustrate various examples. FIG. 8 shows an example 800 of how performing style transfer and multi-view generation from an incomplete set of views. Thus, in FIG. 8, the multi-modal input 150 includes three views 810 of a vehicle, provided as images, and a style example 830, which is another type of vehicle but having a desired style. The design system 100 accepts the inputs 810 and 820 and outputs a set of multi-view images 830 that is comprised of sixteen separate images having the style of the style example 820 but the general form of the views 810. The design system 100 is able to achieve this by encoding the inputs 810 and 820 into a shared latent code using the diffusion model and then applying the image decoder to the shared latent code to output the set of multi-view images in a desired form as represented by the shared latent code.

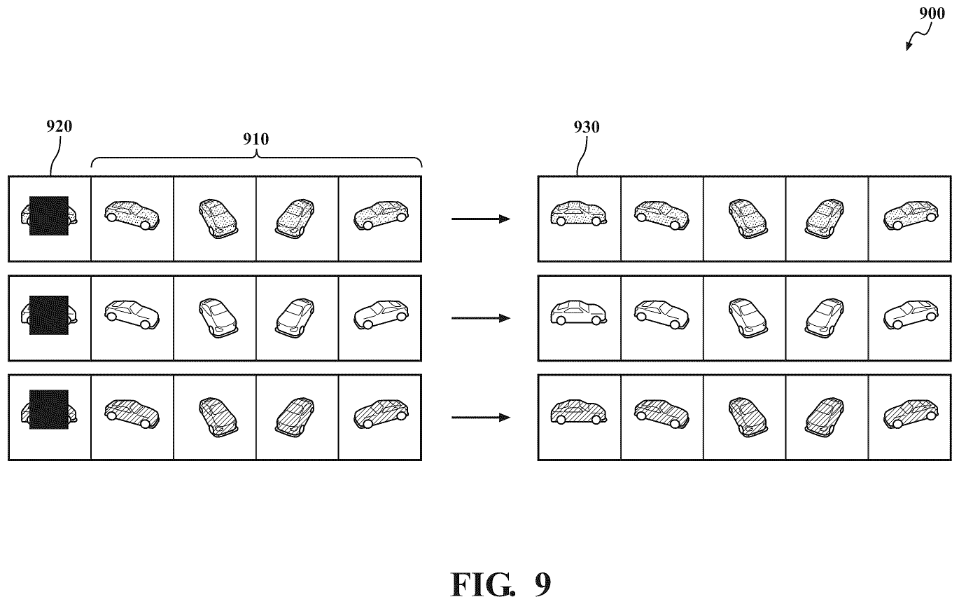

FIG. 9 illustrates another example 900, in which the design system 100 is performing multi-view completion. As shown, the inputs 910 include multi-views of an object. It should be noted that each separate row is a separate independent example. In any case, column 920 represents the missing views that are not available as inputs to the design system 100. Accordingly, the design system 100 accepts the available views of the inputs 910 and generates the completed set of views, including the missing view 930.

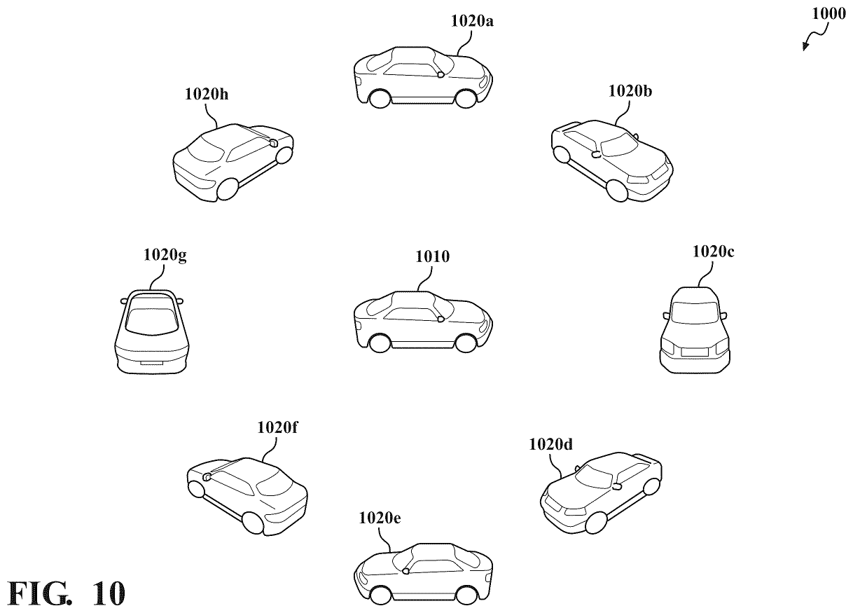

FIG. 10 illustrates an example 1000 of single view to multi-view generation. As shown, a single input view 1010 is provided to the design system 100. The design system 100 is able to leverage the shared latent space according to a latent code generated by the diffusion model based on the input 1010 to generate a full set of multi-view images 1020a-h of the object. Because the shared latent space has a comprehensive understanding of the geometry of objects, the image decoder is able to use the single latent code to construct the multiple separate views in an accurate and consistent manner.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “operatively connected” and “communicatively coupled,” as used throughout this description, can include direct or indirect connections, including connections without direct physical contact.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A design system, comprising:
one or more processors;
a memory communicably coupled to the one or more processors and storing instructions that, when executed by the one or more processors, cause the one or more processors to:
acquire a request to generate an image;
generate a latent code from the request using a diffusion model that learns a shared latent space defining relationships between separate views of objects;
decode the latent code into the image using a decoder trained on the shared latent space; and
provide the image.

2. The design system of claim 1, wherein the instructions to generate the latent code include instructions to add noise to acquired information from the request to form noised information and generate the latent code using the diffusion model to denoise the noised information,
wherein the acquired information includes one or more of a single input image, a set of multi-view images, and a textual description, and
wherein the instructions to decode the latent code into the image include instructions to decode the latent code into multi-view output images that depict an object of the image from multiple separate views.

3. The design system of claim 1, wherein the instructions include instructions to:
generate the shared latent space according to a training dataset that is comprised of multi-view images representing different views of a plurality of objects.

4. The design system of claim 3, wherein the instructions to generate the shared latent space include instructions to train an image model using the training dataset, the image model including an image encoder and an image decoder, and
wherein the instructions to train the image model include instructions to train on a task that includes one of multi-view completion, multi-view style transfer, multi-view editing, unconditional multi-view generation, and single-to-multi-view generation.

5. The design system of claim 3, wherein the instructions to generate the shared latent space include instructions to encode images from the training dataset into a shared latent code that maps to the shared latent space and decoding the shared latent code to re-generate the images, and
wherein the instructions to generate the shared latent space include instructions to compare the images provided as input with the images that have been re-generated to produce a loss value for training the image model to define the shared latent space.

6. The design system of claim 5, wherein the instructions to generate the shared latent space include instructions to train the diffusion model on the shared latent space by adding noise to shared latent codes generated during the training of the image model and applying the diffusion model to denoise the shared latent codes.

7. The design system of claim 1, wherein the instructions to provide the image include instructions to render the image on a display within a vehicle to depict a previously unseen view of an object depicted by the image.

8. The design system of claim 1, wherein the instructions to provide the image include instructions to render the image as part of an advanced driving assistance system (ADAS).

9. A non-transitory computer-readable medium including instructions that, when executed by one or more processors, cause the one or more processors to:
acquire a request to generate an image;
generate a latent code from the request using a diffusion model that learns a shared latent space defining relationships between separate views of objects;
decode the latent code into the image using a decoder trained on the shared latent space; and
provide the image.

10. The non-transitory computer-readable medium of claim 9, wherein the instructions to generate the latent code include instructions to add noise to acquired information from the request to form noised information and generate the latent code using the diffusion model to denoise the noised information,
wherein the acquired information includes one or more of a single input image, a set of multi-view images, and a textual description, and
wherein the instructions to decode the latent code into the image include instructions to decode the latent code into multi-view output images that depict an object of the image from multiple separate views.

11. The non-transitory computer-readable medium of claim 9, wherein the instructions include instructions to:
generate the shared latent space according to a training dataset that is comprised of multi-view images representing different views of a plurality of objects.

12. The non-transitory computer-readable medium of claim 11, wherein the instructions to generate the shared latent space include instructions to train an image model using the training dataset, the image model including an image encoder and an image decoder, and
wherein the instructions to train the image model include instructions to train on a task that includes one of multi-view completion, multi-view style transfer, multi-view editing, unconditional multi-view generation, and single-to-multi-view generation.

13. The non-transitory computer-readable medium of claim 11, wherein the instructions to generate the shared latent space include instructions to encode images from the training dataset into a shared latent code that maps to the shared latent space and decoding the shared latent code to re-generate the images, and
wherein the instructions to generate the shared latent space include instructions to compare the images provided as input with the images that have been re-generated to produce a loss value for training the image model to define the shared latent space.

14. A method, comprising:
acquiring a request to generate an image;
generating a latent code from the request using a diffusion model that learns a shared latent space defining relationships between separate views of objects;
decoding the latent code into the image using a decoder trained on the shared latent space; and
providing the image.

15. The method of claim 14, wherein generating the latent code includes adding noise to acquired information from the request to form noised information and generating the latent code using the diffusion model to denoise the noised information,
wherein the acquired information includes one or more of a single input image, a set of multi-view images, and a textual description, and
wherein decoding the latent code into the image includes decoding the latent code into multi-view output images that depict an object of the image from multiple separate views.

16. The method of claim 14, further comprising:
generating the shared latent space according to a training dataset that is comprised of multi-view images representing different views of a plurality of objects.

17. The method of claim 16, wherein generating the shared latent space includes training an image model using the training dataset, the image model including an image encoder and an image decoder, and
wherein training the image model includes training on a task that includes one of multi-view completion, multi-view style transfer, multi-view editing, unconditional multi-view generation, and single-to-multi-view generation.

18. The method of claim 16, wherein generating the shared latent space includes encoding images from the training dataset into a shared latent code that maps to the shared latent space and decoding the shared latent code to re-generate the images, and
wherein generating the shared latent space includes comparing the images provided as input with the images that have been re-generated to produce a loss value for training the image model to define the shared latent space.

19. The method of claim 18, wherein generating the shared latent space includes training the diffusion model on the shared latent space by adding noise to shared latent codes generated during the training of the image model and applying the diffusion model to denoise the shared latent codes.

20. The method of claim 14, where providing the image includes rendering the image on a display within a vehicle to depict a previously unseen view of an object depicted by the image.
